(19) United States
(12) Patent Application Publication
(10) Pub. No.: US 2025/0365645 A1
(43) Pub. Date: Nov. 27, 2025

(54) METHOD AND APPARATUS FOR ACCESS BARRING CHECK BASED ON HEIGHT IN A WIRELESS COMMUNICATION SYSTEM

(71) Applicant: LG ELECTRONICS INC., Seoul (KR)

(72) Inventors: Myoungsoo KIM, Seoul (KR); Sunghoon JUNG, Seoul (KR)

(21) Appl. No.: 18/872,505

(22) PCT Filed: Jun. 30, 2023
(86) PCT No.: PCT/KR2023/009201

§ 371 Date: Dec. 6, 2024

Related U.S. Application Data
(60) Provisional application No. 63/357,652, filed on Jul. 1, 2022.

(51) Int. Cl. H04W 48/04; H04W 64/00; H04W 84/04

(52) U.S. Cl. CPC H04W 48/04; H04W 64/00; H04W 84/042

(57) ABSTRACT

A method and apparatus for access barring check based on height in a wireless communication system is provided. The wireless device receives, from a network, at least one access barring configuration. Each of the at least one access barring configuration is associated with one or more location ranges. The wireless device determines a certain access barring configuration associated with a certain location range to which a current location of the wireless device belongs. The wireless device performs an access barring check based on the certain access barring configuration.

### TECHNICAL FIELD

The present disclosure relates to a method and apparatus for access barring check based on height in a wireless communication system.

### BACKGROUND ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

[3] Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

[4] The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### DISCLOSURE OF INVENTION

### Technical Problem

[5] There is a mechanism for access restriction referred to as Unified Access Control, and selected access categories or access identities are prevented from sending initial access messages for load control reasons. The network configures barring control information associated with access categories and access identities. The UE determines whether an access attempt is barred based on the barring control information for the selected PLMN, and the selected access category and access identities for the access attempt.

[6] There are two reasons to restrict access attempts, depending on the UE mode, i.e. whether it is an aerial UE mode or a terrestrial UE mode.

[7] Firstly, the network may limit access attempts by UEs above a certain height for a certain access category or a certain access identity to reduce UL interference. The network may also be different type, i.e., aerial UEs specific cell or terrestrial UEs specific cell. Then, the UE mode for which the network focus on the connection may be different depending on the network type.

[8] Secondly, for the aerial UEs, a swarm of aerial UEs can be used to improve the efficiency of tasks such as delivery, agriculture, and emergency rescue, and this swarm of aerial UEs may be managed by a network. However, the network is burdened with controlling multiple aerial UEs in addition to terrestrial UEs. In such case, the network may need access control for load balancing based on UE mode, i.e. whether it is an aerial UE mode or a terrestrial UE mode.

[9] If the network performs access control with the height condition other than selected PLMN, access category and access identities, the network can efficiently perform load balancing in consideration of aerial UEs and reduce waste of UL resources for a certain height.

Therefore, studies for access barring check based on height in a wireless communication system are required.

### Solution to Problem

In an aspect, a method performed by a wireless device in a wireless communication system is provided. The wireless device receives, from a network, at least one access barring configuration. Each of the at least one access barring configuration is associated with one or more location ranges. The wireless device determines a certain access barring configuration associated with a certain location range to which a current location of the wireless device belongs. The wireless device performs an access barring check based on the certain access barring configuration.

In another aspect, an apparatus for implementing the above method is provided.

### Advantageous Effects of Invention

The present disclosure can have various advantageous effects.

According to some embodiments of the present disclosure, a wireless device could efficiently perform access barring check based on the current height.

For example, if the network performs access control with the height condition other than selected PLMN, access category and access identities, the network can efficiently perform load balancing in consideration of aerial UEs and reduce waste of UL resources for a certain height.

In other words, by implementing access control based on height conditions, in addition to selected PLMN, access categories, and access identities, the network can efficiently perform load balancing while taking into consideration aerial UEs, thereby reducing wastage of uplink (UL) resources for UEs operating at specific heights.

For example, by implementing location-based access control, it is possible to efficiently distribute the network load from aerial UEs.

For example, efficient utilization of resources is enabled for UEs located in specific locations.

For example, by applying access barring configuration based on location, UEs can connect to the network efficiently.

According to some embodiments of the present disclosure, a wireless network system could provide an efficient solution for access barring check considering the height of the wireless device.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a method for access barring check based on height in a wireless communication system, according to some embodiments of the present disclosure.

FIG. 11 shows some an example of a method for access barring check based on height in a wireless communication system, according to some embodiments of the present disclosure.

FIGS. 12, 13, 14, 15, and 16 show examples of barring control information over height configurations.

FIG. 17 shows an example of different barring information based on the location.

### MODE FOR THE INVENTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”.

For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

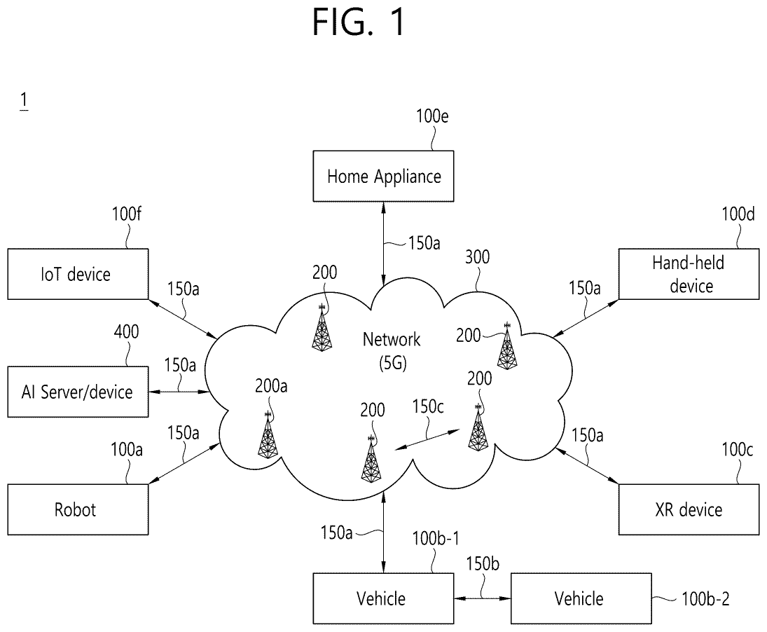

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

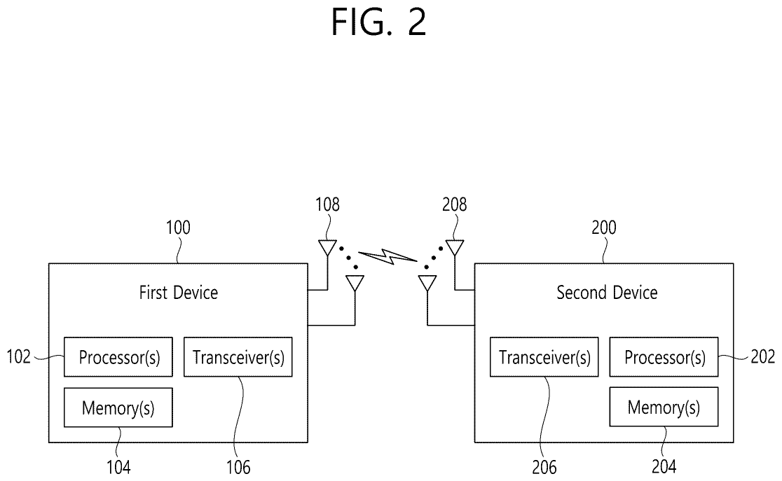

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to ′} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

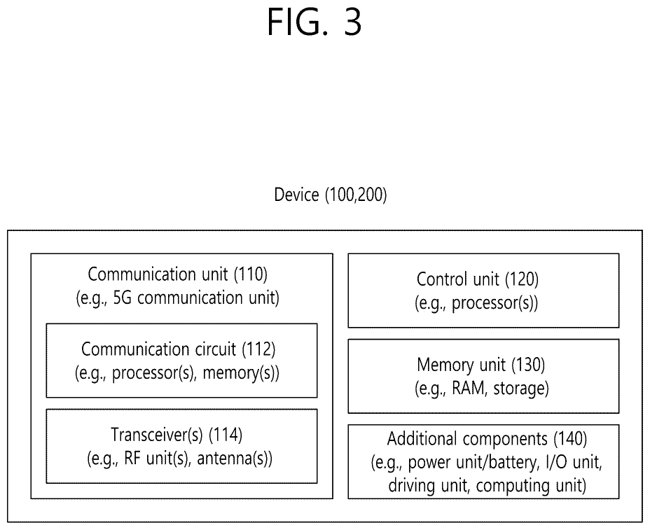

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2.

For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc.

The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

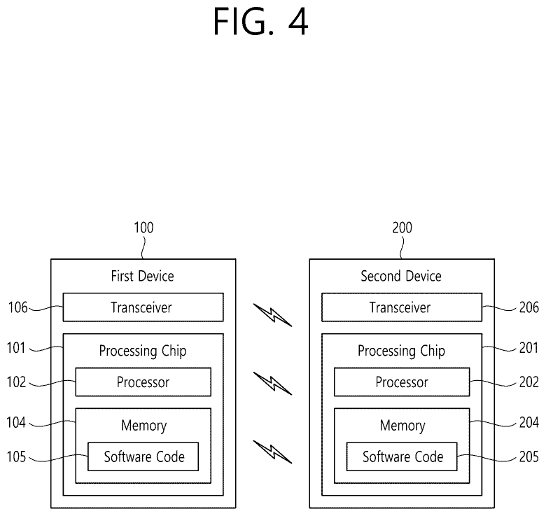

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

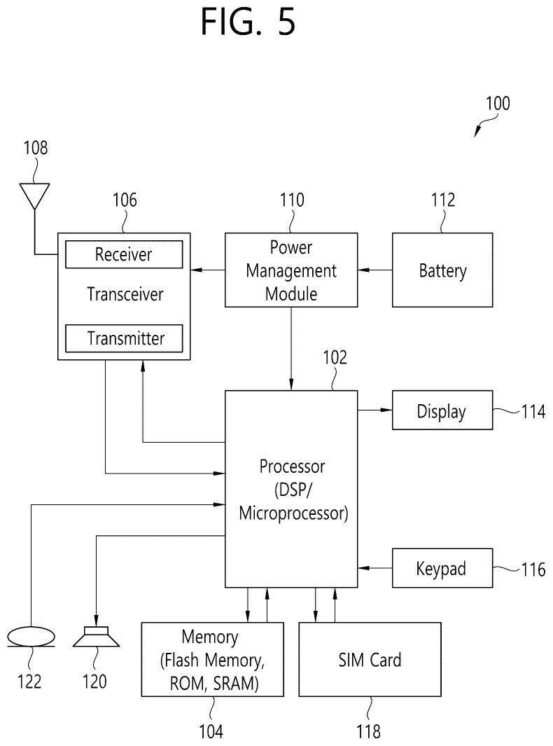

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

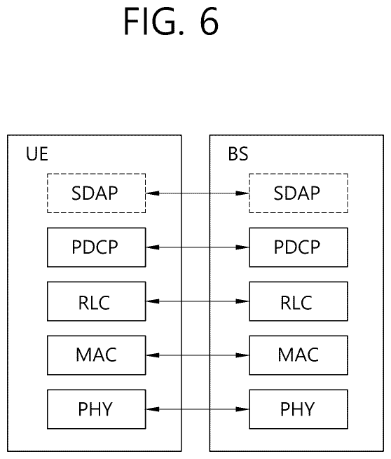

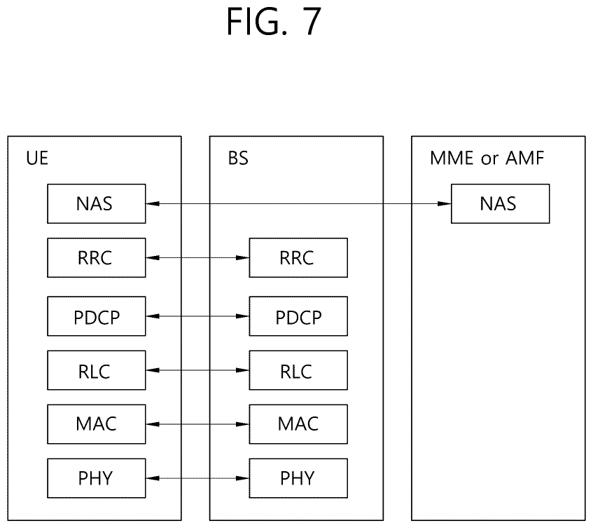

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology (ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data;

reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or

NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

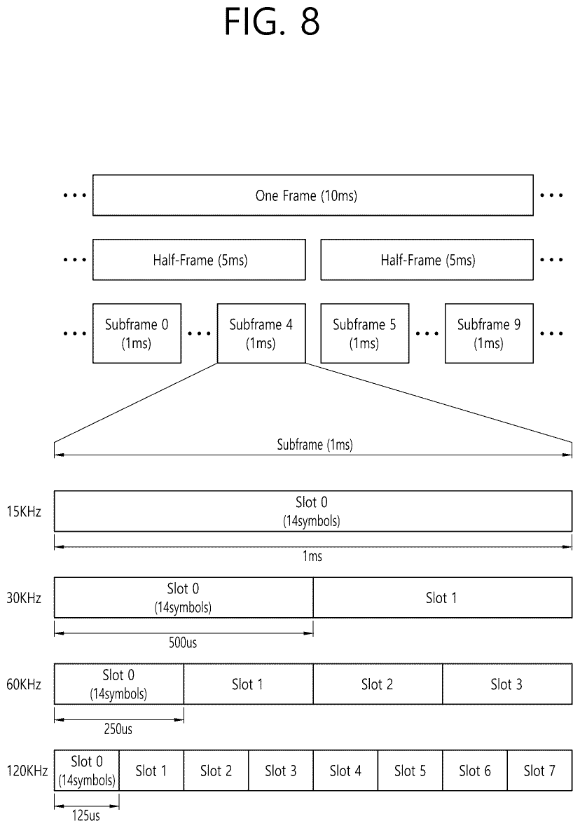

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame.u}ₛₗₒₜ, and the number of slots per subframe N^{subframe.u}ₛₗₒₜ for the normal CP, according to the subcarrier spacing Δf=2^{u}*15 KHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame.u}ₛₗₒₜ, and the number of slots per subframe N^{subframe.u}ₛₗₒₜ for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size.u}_{grid.x}*N^{RB}_{SC} subcarriers and N^{subframe.u}_{symb} OFDM symbols is defined, starting at common resource block (CRB) N^{start.u}_{grid} indicated by higher-layer signaling (e.g., RRC signaling), where N^{size.u}_{grid.x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size.u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP.i}−1, where i is the number of the bandwidth part. The relation between the physical resource block n_{PRB} in the bandwidth part i and the common resource block n_{CRB} is as follows: n_{PRB}=N_{CRB}+N^{size}_{BWP.i}, where N^{size}_{BWP.i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHZ, etc.) or more. For example, a frequency band of 6 GHZ (or 5850, 5900, 5925 MHZ, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

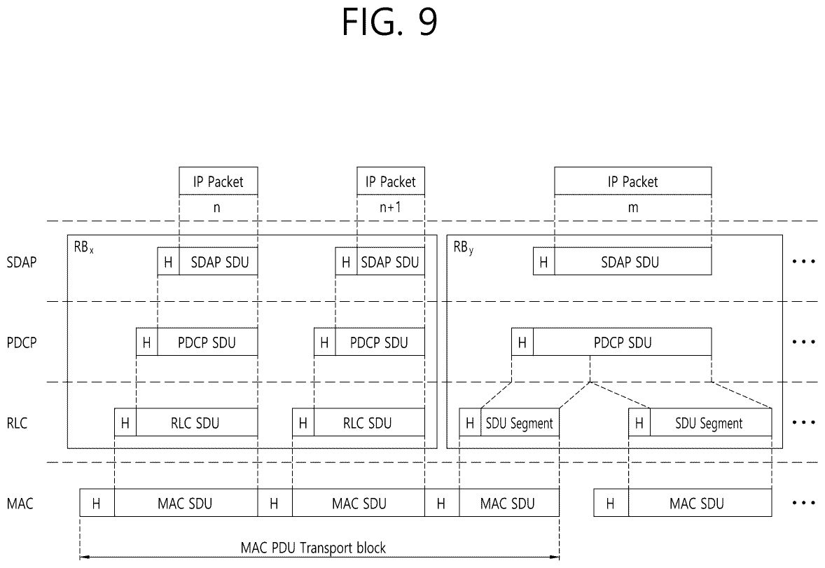

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to the flight path are described. Parts of section 5.3.3.4, 5.5.4.16, 5.5.4.17, 5.6.5.3, and 6.2.2 of 3GPP TS 36.331 v16.6.0 may be referred.

Operations related to reception of the RRCConnectionSetup by the UE are described.

The UE shall:
1> set the content of RRCConnectionSetupComplete message as follows:
2> if the UE is connected to EPC:
3> except for NB-IoT:
4> include the mobilityState and set it to the mobility state of the UE just prior to entering RRC_CONNECTED state;
4> if the UE has flight path information available:
5> include flightPathInfoAvailable;
Operations related to reception of the UEInformationRequest message are described.
1> except for NB-IoT, if flightPathInfoReq field is present and the UE has flight path information available:
2> include the flightPathInfoReport and set it to include the list of waypoints along the flight path;
2> if the includeTimeStamp is set to TRUE:
3> set the field timeStamp to the time when UE intends to arrive to each waypoint if this information is available at the UE;

Technical features related to a UEInformationRequest message are described. The UEInformationRequest is the command used by E-UTRAN to retrieve information from the UE.

For example, signalling radio bearer for the UEInformationRequest may include SRB1. RLC-Service Access Point (SAP) for the UEInformationRequest may include AM. Logical channel for the UEInformationRequest may include DCCH. Direction for the UEInformation Request may be E-UTRAN to UE.

The UEInformationRequest may include information on a flightPathInfoReq (for example, FlightPathInfoReportConfig) and/or information on nonCriticalExtension.

Technical features related to a UEInformationResponse message are described. For example, the UEInformationResponse message is used by the UE to transfer the information requested by the E-UTRAN.

For example, signalling radio bearer for the UEInformationResponse may include SRB1 or SRB2 (when logged measurement information is included). RLC-SAP for the UEInformationResponse may include an AM. Logical channel for the UEInformationResponse may include a DCCH. Direction for the UEInformationResponse may be UE to E-UTRAN.

For example, UEInformationResponse message may include a flightPathInfoReport. For example, the flightPathInfoReport may include information on one or more flightPaths and/or one or more wayPointLocations.

Technical features related to LocationInfo are described. For example, the IE LocationInfo is used to transfer detailed location information available at the UE to correlate measurements and UE position information.

For example, LocationInfo information element may include verticalVelocityInfo including information on a verticalVelocity and a verticalVelocity AndUncertainty.

For example, a verticalVelocity AndUncertainty may include information on a parameter verticalVelocity AndUncertainty corresponds to horizontalWith VerticalVelocityAndUncertainty. The first/leftmost bit of the first octet contains the most significant bit.

For example, a verticalVelocity may include information on a parameter verticalVelocity corresponds to horizontalWith VerticalVelocity. The first/leftmost bit of the first octet contains the most significant bit.

UE operations related to Event H1 (The Aerial UE height is above a threshold) are described.

The UE shall:
1> consider the entering condition for this event to be satisfied when condition H1−1, as specified below, is fulfilled;
1> consider the leaving condition for this event to be satisfied when condition H1-2, as specified below, is fulfilled;

Inequality H1−1 (Entering condition)

Ms-Hys> Thresh+Offset

Inequality H1-2 (Leaving condition)

Ms+Hys<Thresh+Offset

The variables in the formula are defined as follows:

Ms is the Aerial UE height, not taking into account any offsets.

Hys is the hysteresis parameter (i.e. hl-Hysteresis as defined within ReportConfigEUTRA) for this event.

Thresh is the reference threshold parameter for this event given in MeasConfig (i.e. heightThreshRef as defined within MeasConfig).

Offset is the offset value to heightThreshRef to obtain the absolute threshold for this event. (i.e. hl-ThresholdOffset as defined within ReportConfigEUTRA)

Ms is expressed in meters.

Thresh is expressed in the same unit as Ms.

UE operations related to Event H2 (The Aerial UE height is below a threshold) are described.

The UE shall:
1> consider the entering condition for this event to be satisfied when condition H2−1, as specified below, is fulfilled;
1> consider the leaving condition for this event to be satisfied when condition H2-2, as specified below, is fulfilled;
Inequality H2−1 (Entering condition)

Ms+Hys<Thresh+Offset

Inequality H2-2 (Leaving condition)

Ms-Hys> Thresh+Offset

The variables in the formula are defined as follows:

Ms is the Aerial UE height, not taking into account any offsets.

Hys is the hysteresis parameter (i.e. h2-Hysteresis as defined within ReportConfigEUTRA) for this event.

Thresh is the reference threshold parameter for this event given in MeasConfig (i.e. heightThreshRef as defined within MeasConfig).

Offset is the offset value to heightThreshRef to obtain the absolute threshold for this event. (i.e. h2-ThresholdOffset as defined within ReportConfigEUTRA)

Ms is expressed in meters.

Thresh is expressed in the same unit as Ms.

Hereinafter, technical features related to Aerial UE communication are described.

Parts of section 23.17 of 3GPP TS 36.300 v16.5.0 may be referred.

E-UTRAN based mechanisms providing LTE connection to UEs capable of Aerial communication are supported via the following functionalities:
subscription-based Aerial UE identification and authorization.
height reporting based on the event that the UE's altitude has crossed a network-configured reference altitude threshold.
interference detection based on a measurement reporting that is triggered when a configured number of cells (i.e. larger than one) fulfills the triggering criteria simultaneously.
signalling of flight path information from UE to E-UTRAN.
Location information reporting, including UE's horizontal and vertical velocity.

[Subscription based identification of Aerial UE function]

Support of Aerial UE function is stored in the user's subscription information in HSS. HSS transfers this information to the MME during Attach, Service Request and Tracking

Area Update procedures.

The subscription information can be provided from the MME to the eNB via the S1 AP Initial Context Setup Request during Attach, Tracking Area Update and Service Request procedures. In addition, for X2-based handover, the source eNodeB can include the subscription information in the X2-AP Handover Request message to the target eNodeB.

For the intra and inter MME S1 based handover, the MME provides the subscription information to the target eNB after the handover procedure.

### [Height Based Reporting for Aerial UE Communication]

An aerial UE can be configured with event based height reporting. UE sends height report when the altitude of the aerial UE is above or below a configured threshold. The report contains height and location if configured.

### [Interference Detection and Mitigation for Aerial UE Communication]

For interference detection, an aerial UE can be configured with RRM event A3, A4 or A5 that triggers measurement report when individual (per cell) RSRP values for a configured number of cells fulfil the configured event. The report contains RRM results and location if configured.

For interference mitigation an aerial UE can be configured with a dedicated UE-specific alpha parameter for PUSCH power control.

### [Flight Path Information Reporting]

E-UTRAN can request a UE to report flight path information consisting of a number of waypoints defined as 3D locations. A UE reports up to configured number of waypoints if flight path information is available at the UE. The report can consist also time stamps per waypoint if configured in the request and if available at the UE.

### [Location Reporting for Aerial UE Communication]

Location information for Aerial UE communication can include horizontal and vertical speed if configured. Location information can be included in RRM report and in height report.

Hereinafter, technical features related to Access Control are described. Parts of section 7.4 of 3GPP TS 38.300 v17.0.0 may be referred.

NG-RAN supports overload and access control functionality such as RACH back off, RRC Connection Reject, RRC Connection Release and UE based access barring mechanisms.

One unified access control framework applies to all UE states (RRC_IDLE, RRC_INACTIVE and RRC_CONNECTED) for NR. NG-RAN broadcasts barring control information associated with Access Categories and Access Identities (in case of network sharing, the barring control information can be set individually for each PLMN). The UE determines whether an access attempt is authorized based on the barring information broadcast for the selected PLMN, and the selected Access Category and Access Identity (ies) for the access attempt:
For NAS triggered requests, NAS determines the Access Category and Access Identity (ies);
For AS triggered requests, RRC determines the Access Category while NAS determines the Access Identity (ies).

The gNB handles access attempts with establishment causes “emergency”, “mps-Priority Access” and “mcs-Priority Access” (i.e. Emergency calls, MPS, MCS subscribers) with high priority and responds with RRC Reject to these access attempts only in extreme network load conditions that may threaten the gNB stability.

Unified access control does not apply to IAB-MTs.

Hereinafter, technical features related to Cell Reservations and Access Restrictions are described. Parts of section 5.3 of 3GPP TS 38.304 v17.0.0 may be referred.

There are two mechanisms which allow an operator to impose cell reservations or access restrictions. The first mechanism uses indication of cell status and special reservations for control of cell selection and reselection procedures. The second mechanism, referred to as Unified Access Control, shall allow preventing selected access categories or access identities from sending initial access messages for load control reasons.

Unified Access Control does not apply to IAB-MTs.

Cell status and cell reservations are indicated in the MIB or SIB1 message by means of following fields:
cellBarred (IE type: “barred” or “not barred”)

Indicated in MIB message. In case of multiple PLMNs or NPNs indicated in SIB1, this field is common for all PLMNs and NPNs.
cellBarredRedCap1Rx (IE type: “barred” or “not barred”)

Indicated in SIB1 message. In case of multiple PLMNs or NPNs indicated in SIB1, this field is common for all PLMNs and NPNs. This field is only applicable to RedCap UEs.
cellBarredRedCap2Rx (IE type: “barred” or “not barred”)

Indicated in SIB1 message. In case of multiple PLMNs or NPNs indicated in SIB1, this field is common for all PLMNs and NPNs. This field is only applicable to RedCap UEs.
cellReservedForOperatorUse (IE type: “reserved” or “not reserved”)

Indicated in SIB1 message. In case of multiple PLMNs or NPNs indicated in SIB1, this field is specified per PLMN or per SNPN.
cellReservedForOtherUse (IE type: “true”)

Indicated in SIB1 message. In case of multiple PLMNs indicated in SIB1, this field is common for all PLMNs.
cellReservedForFutureUse (IE type: “true”)

Indicated in SIB1 message. In case of multiple PLMNs or NPNs indicated in SIB1, this field is common for all PLMNs and NPNs.

IAB-MT ignores the cellBarred, cellReservedForOperatorUse, cellReservedForFutureUse, and intraFreqReselection (i.e. treats intraFreqReselection as if it was set to allowed). IAB-MT also ignores cellReservedForOtherUse for cell barring determination (i.e. NPN capable IAB-MT considers cellReservedForOtherUse for determination of an NPN-only cell).
iab-Support (IE type: “true”)

Indicated in SIB1 message. In case of multiple PLMNs or NPNs indicated in SIB1, this field is specified per PLMN or per SNPN.

When cell status is indicated as “not barred” and “not reserved” for operator use and

not “true” for other use and not “true” for future use,
UEs shall treat this cell as candidate during the cell selection and cell reselection procedures.

When cell broadcasts any CAG-IDs or NIDs and the cell status is indicated as “not barred” and “not reserved” for operator use and “true” for other use, and not “true” for future use:
All NPN-capable UEs shall treat this cell as candidate during the cell selection and cell reselection procedures, other UEs shall treat this cell as if cell status is “barred”.

When cell status is indicated as “true” for other use, and either cell does not broadcast any CAG-IDs or NIDs or does not broadcast any CAG-IDs and the UE is not operating in SNPN Access Mode,
The UE shall treat this cell as if cell status is “barred”.

When cell status is indicated as “true” for future use,
The UE shall treat this cell as if cell status is “barred”.

When cell status is indicated as “not barred” and “reserved” for operator use for any PLMN/SNPN and not “true” for other use and not “true” for future use,
UEs assigned to Access Identity 11 or 15 operating in their HPLMN/EHPLMN shall treat this cell as candidate during the cell selection and reselection procedures if the field cellReservedForOperatorUse for that PLMN set to “reserved”.
UEs assigned to Access Identity 11 or 15 shall treat this cell as candidate during the cell selection and reselection procedures if the field cellReservedForOperatorUse for selected/registered SNPN is set to “reserved”.
UEs assigned to an Access Identity 0, 1, 2 and 12 to 14 shall behave as if the cell status is “barred” in case the cell is “reserved for operator use” for the registered PLMN/SNPN or the selected PLMN/SNPN.
UEs assigned to Access Identity 3 shall behave as if the cell status is “barred” in case the cell is “reserved for operator use” for the registered PLMN or the selected PLMN.
Access Identities 11, 15 are only valid for use in the HPLMN/EHPLMN; Access Identities 12, 13, 14 are only valid for use in the home country.
Access Identity 3 is only valid for PLMNs that indicate to potential Disaster Inbound Roamers that the UEs can access the PLMN.

The cell selection of another cell may also include a change of RAT.

If barring of a cell is triggered by the condition of trackingAreaCode and trackingAreaList not being provided, the barring only applies to this PLMN and the UE can re-evaluate the barring condition again due to selection of another PLMN.

Unified access control is described.

The information on cell access restrictions associated with Access Categories and Identities is broadcast in SIB1 as part of Unified Access Control.

The UE shall ignore Access Category and Identity related cell access restrictions for cell reselection. A change of the indicated access restriction shall not trigger cell reselection by the UE.

The UE shall consider Access Category and Identity related cell access restrictions for NAS initiated access attempts and RNAU.

A L2 U2N Relay UE does not need to perform the Unified Access Control, due to the U2N Remote UE access attempt.

Hereinafter, technical features related to RRC connection resume are described. Parts of section 5.3.13 of 3GPP TS 38.331 v17.0.0 may be referred.

The UE initiates the procedure when upper layers or AS (when responding to RAN paging, upon triggering RNA updates while the UE is in RRC_INACTIVE, for NR sidelink communication/V2X sidelink communication) requests the resume of a suspended RRC connection or for initiating SDT.

The UE shall ensure having valid and up to date essential system information before initiating this procedure.

Upon initiation of the procedure, the UE shall:
1> if the resumption of the RRC connection is triggered by response to NG-RAN paging:
2> select ‘0’ as the Access Category;
2> perform the unified access control procedure using the selected Access Category and one or more Access Identities provided by upper layers;
3> if the access attempt is barred, the procedure ends;
1> else if the resumption of the RRC connection is triggered by upper layers:
2> if the upper layers provide an Access Category and one or more Access Identities:
3> perform the unified access control procedure using the Access Category and Access Identities provided by upper layers;
4> if the access attempt is barred, the procedure ends;
2> if the resumption occurs after release with redirect with mpsPriorityIndication:
3> set the resumeCause to mps-Priority Access;
2> else:
3> set the resumeCause in accordance with the information received from upper layers;
1> else if the resumption of the RRC connection is triggered due to an RNA update:
2> if an emergency service is ongoing:
3> select ‘2’ as the Access Category;
3> set the resumeCause to emergency;
2> else:
3> select ‘8’ as the Access Category;
2> perform the unified access control procedure using the selected Access Category and one or more Access Identities to be applied;
3> if the access attempt is barred:
4> set the variable pendingRNA-Update to true;
4> the procedure ends;

Hereinafter, technical features related to Unified Access Control are described. Parts of section 5.3.14 of 3GPP TS 38.331 v17.0.0 may be referred.

The purpose of this procedure is to perform access barring check for an access attempt associated with a given Access Category and one or more Access Identities upon request from upper layers or the RRC layer. This procedure does not apply to IAB-MT. This procedure does not apply to L2 U2N Relay UE initiating RRC connection establishment or RRC connection resume upon reception of any message from a L2 U2N remote UE via SL-RLC0 or SL-RLC.

After a PCell change in RRC_CONNECTED the UE shall defer access barring checks until it has obtained SIB1 from the target cell.

Upon initiation of the procedure, the UE shall:
1> if timer T390 is running for the Access Category:
2> consider the access attempt as barred;
1> else if timer T302 is running and the Access Category is neither ‘2’ nor ‘0’:
2> consider the access attempt as barred;
1> else:
2> if the Access Category is ‘0’:
3> consider the access attempt as allowed;
2> else:
3> if SIB1 includes uac-BarringPerPLMN-List that contains a UAC-BarringPerPLMN for the selected PLMN or SNPN:
4> if the procedure for a selected PLMN resulted in use of information in npn-IdentityInfoList and UAC-BarringPerPLMN has an entry with the plmn-IdentityIndex corresponding to used information in this list:
5> select the UAC-BarringPerPLMN entry with the plmn-IdentityIndex corresponding to used information in the npn-IdentityInfoList;
4> else:
5> select the UAC-BarringPerPLMN entry with the plmn-IdentityIndex corresponding to the selected PLMN and the PLMN-IdentityInfo, if any, or the selected SNPN and the npn-IdentityInfoList;
3> if any UAC-BarringPerPLMN entry is selected:
4> in the remainder of this procedure, use the selected UAC-BarringPerPLMN entry (i.e. presence or absence of access barring parameters in this entry) irrespective of the uac-BarringForCommon included in SIB1;
3> else if SIB1 includes uac-Barring ForCommon:
4> in the remainder of this procedure use the uac-BarringForCommon (i.e. presence or absence of these parameters) included in SIB1;
3> else:
4> consider the access attempt as allowed;
3> if uac-BarringForCommon is applicable or the uac-ACBarringListType indicates that uac-ExplicitACBarring List is used:
4> if the corresponding UAC-BarringPerCatList contains a UAC-BarringPerCat entry corresponding to the Access Category:
5> select the UAC-BarringPerCat entry;
5> if the uac-BarringInfoSetList contains a UAC-BarringInfoSet entry corresponding to the selected uac-barringInfoSetIndex in the UAC-BarringPerCat:
6> select the UAC-BarringInfoSet entry;
6> perform access barring check for the Access Category, using the selected UAC-BarringInfoSet as “UAC barring parameter”;
5> else:
6> consider the access attempt as allowed;
4> else:
5> consider the access attempt as allowed;
3> else if the uac-ACBarringListType indicates that uac-ImplicitACBarringList is used:
4> select the uac-BarringInfoSetIndex corresponding to the Access Category in the uac-ImplicitACBarringList;
4> if the uac-BarringInfoSetList contains the UAC-BarringInfoSet entry corresponding to the selected uac-BarringInfoSetIndex:
5> select the UAC-BarringInfoSet entry;
5> perform access barring check for the Access Category, using the selected UAC-BarringInfoSet as “UAC barring parameter”;
4> else:
5> consider the access attempt as allowed;
3> else:
4> consider the access attempt as allowed;
1> if the access barring check was requested by upper layers:
2> if the access attempt is considered as barred:
3> if timer T302 is running:
4> if timer T390 is running for Access Category ‘2’:
5> inform the upper layer that access barring is applicable for all access categories except categories ‘0’, upon which the procedure ends;
4> else
5> inform the upper layer that access barring is applicable for all access categories except categories ‘0’ and ‘2’, upon which the procedure ends;
3> else:
4> inform upper layers that the access attempt for the Access Category is barred, upon which the procedure ends;
2> else:
3> inform upper layers that the access attempt for the Access Category is allowed, upon which the procedure ends;
1> else:
2> the procedure ends.

Technical features related to Access barring check are discribed.

The UE shall:
1> if one or more Access Identities equal to 1, 2, 11, 12, 13, 14, or 15 are indicated, and
1> if for at least one of these Access Identities the corresponding bit in the uac-BarringForAccessIdentity contained in “UAC barring parameter” is set to zero:
2> consider the access attempt as allowed;
1> else:
2> if the establishment of the RRC connection is the result of release with redirect with mpsPriorityIndication (either in NR or E-UTRAN); and
2> if the bit corresponding to Access Identity 1 in the uac-BarringForAccessIdentity contained in the “UAC barring parameter” is set to zero:
3> consider the access attempt as allowed;
2> else if Access Identity 3 is indicated:
3> draw a random number ‘rand’ uniformly distributed in the range: 0≤rand <
1;
3> if ‘rand’ is lower than the value indicated by uac-BarringFactorForAl3 included in “UAC barring parameter”:
4> consider the access attempt as allowed;
3> else:
4> consider the access attempt as barred;
2> else:
3> draw a random number ‘rand’ uniformly distributed in the range: 0≤rand <1;
3> if ‘rand’ is lower than the value indicated by uac-BarringFactor included in “UAC barring parameter”:
4> consider the access attempt as allowed;
3> else:
4> consider the access attempt as barred;
1> if the access attempt is considered as barred:
2> draw a random number ‘rand’ that is uniformly distributed in the range 0≤ rand <1;
2> start timer T390 for the Access Category with the timer value calculated as follows, using the uac-BarringTime included in “UAC barring parameter”: T390=(0.7+0.6· rand)· uac-BarringTime.
Table 5 shows an example of SIB1 message.

TABLE 5
-- ASN1START
-- TAG-SERVINGCELLCONFIGCOMMON-START

| | |
|---|---|
| SIB 1 ::= | SEQUENCE { |
| cellSelectionInfo | SEQUENCE { ...} |
| uac-BarringInfo | SEQUENCE { |

| | |
|---|---|
| uac-BarringForCommon | UAC-BarringPerCatList |

OPTIONAL, -- Need S

| | |
|---|---|
| uac-BarringPerPLMN-List | UAC-BarringPerPLMN-List |

OPTIONAL, -- Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |
| individualPLMNList | SEQUENCE (SIZE (2..maxPLMN)) OF UAC- |

AccessCategory1-SelectionAssistanceInfo
}

| | |
|---|---|
| SIB1-v1630-IEs ::= | SEQUENCE { |
| uac-BarringInfo-v1630 | SEQUENCE { |

| | |
|---|---|
| uac-AC1-SelectAssistInfo-r16 | SEQUENCE (SIZE (2..maxPLMN)) OF UAC-AC1- |

SelectAssistInfo-r16
}...}

| | |
|---|---|
| SIB1-v1700-IEs ::= | SEQUENCE { |

| | |
|---|---|
| hsdn-Cell-r17 | ENUMERATED {true} |

OPTIONAL, -- Need R

| | |
|---|---|
| ue-TimersAndConstants-RemoteUE-r17 | UE-TimersAndConstants-RemoteUE-r17 |

OPTIONAL, -- Need R

| | |
|---|---|
| uac-BarringInfo-v1700 | SEQUENCE { |

| | |
|---|---|
| uac-BarringInfoSetList-v1700 | UAC-BarringInfoSetList-v1700 |

OPTIONAL -- Cond MINT
}...}

uac-BarringForCommon

Common access control parameters for each access category. Common values are used for all PLMNs/SNPNs, unless overwritten by the PLMN/SNPN specific configuration provided in uac-BarringPerPLMN-List. The parameters are specified by providing an index to the set of configurations (uac-BarringInfoSetList). UE behaviour

Technical features related to UAC-BarringPerPLMN-List are described.

The IE UAC-BarringPerPLMN-List provides access category specific access control parameters, which are configured per PLMN/SNPN.

Table 6 shows an example of UAC-BarringPerPLMN-List information element.

TABLE 6
-- ASN1START
-- TAG-UAC-BARRINGPERPLMN-LIST-START

| | |
|---|---|
| UAC-BarringPerPLMN-List ::= | SEQUENCE (SIZE (1..maxPLMN)) OF UAC- |

BarringPerPLMN

| | |
|---|---|
| UAC-BarringPerPLMN ::= | SEQUENCE { |
| plmn-IdentityIndex | INTEGER (1..maxPLMN), |
| uac-ACBarringListType | CHOICE{ |
| uac-ImplicitACBarringList | SEQUENCE (SIZE(maxAccessCat-1)) OF UAC- |

BarringInfoSetIndex,

| | |
|---|---|
| uac-ExplicitACBarringList | UAC-BarringPerCatList |

| | |
|---|---|
| } | OPTIONAL -- Need S |

}
-- TAG-UAC-BARRINGPERPLMN-LIST-STOP
-- ASN1STOP

UAC-BarringPerPLMN-List field descriptions:

uac-ACBarringListType

Access control parameters for each access category valid only for a specific PLMN or SNPN.

5-plmn-IdentityIndex

Index of the PLMN or SNPN across the plmn-IdentityInfoList and npn-IdentityInfoList fields included in SIB1.

Technical features related to UAC-BarringInfoSetList are described.

The IE UAC-BarringInfoSetList provides a list of access control parameter sets. An access category can be configured with access parameters according to one of the sets.

Table 7 shows an example of UAC-BarringInfoSetList information element.

TABLE 7
-- ASN1START
-- TAG-UAC-BARRINGINFOSETLIST-START

| | |
|---|---|
| UAC-BarringInfoSetList ::= | SEQUENCE (SIZE(1..maxBarringInfoSet)) OF UAC- |

BarringInfoSet

| | |
|---|---|
| UAC-BarringInfoSetList-v1700 ::= | SEQUENCE (SIZE(1..maxBarringInfoSet)) OF UAC- |

BarringInfoSet-v1700

| | |
|---|---|
| UAC-BarringInfoSet ::= | SEQUENCE { |

| | |
|---|---|
| uac-BarringFactor | ENUMERATED {p00, p05, p10, p15, p20, p25, p30, p40, |

p50, p60, p70, p75, p80, p85, p90, p95},

| | |
|---|---|
| uac-BarringTime | ENUMERATED {s4, s8, s16, s32, s64, s128, s256, s512}, |

| | |
|---|---|
| uac-BarringForAccessIdentity | BIT STRING (SIZE(7)) |

}
UAC-BarringInfoSet-v1700 ::= SEQUENCE {

| | |
|---|---|
| uac-BarringFactorForAI3-r17 | ENUMERATED {p00, p05, p10, p15, p20, p25, p30, p40, |

| | |
|---|---|
| p50, p60, p70, p75, p80, p85, p90, p95} | OPTIONAL -- Need S |

}
-- TAG-UAC-BARRINGINFOSETLIST-STOP
-- ASN1STOP

UAC-BarringInfoSetList field descriptions:

uac-BarringInfoSetList

List of access control parameter sets. Each access category can be configured with access parameters corresponding to a particular set by uac-barringInfoSetIndex. Association of an access category with an index that has no corresponding entry in the uac-BarringInfoSetList is valid configuration and indicates no barring.

uac-BarringForAccessIdentity

Indicates whether access attempt is allowed for each Access Identity. The leftmost bit, bit 0 in the bit string corresponds to Access Identity 1, bit 1 in the bit string corresponds to Access Identity 2, bit 2 in the bit string corresponds to Access Identity 11, bit 3 in the bit string corresponds to Access Identity 12, bit 4 in the bit string corresponds to Access Identity 13, bit 5 in the bit string corresponds to Access Identity 14, and bit 6 in the bit string corresponds to Access Identity 15. Value 0 means that access attempt is allowed for the corresponding access identity.

uac-BarringFactor Represents the probability that access attempt would be allowed during access

barring check.

uac-BarringFactorForAI3

Barring factor applicable for Access Identity 3. Represents the probability that access attempt would be allowed during access barring check. If absent, the UE considers the access attempt as allowed.

uac-BarringTime

The average time in seconds before a new access attempt is to be performed after an access attempt was barred at access barring check for the same access category.

Technical features related to UAC-BarringPerPLMN-List are described.

The IE UAC-BarringPerPLMN-List provides access category specific access control parameters, which are configured per PLMN/SNPN.

Table 8 shows an example of UAC-BarringPerPLMN-List information element.

TABLE 8
-- ASN1START
-- TAG-UAC-BARRINGPERPLMN-LIST-START

| | |
|---|---|
| UAC-BarringPerPLMN-List ::= | SEQUENCE (SIZE (1.. maxPLMN)) OF UAC- |

BarringPerPLMN

| | |
|---|---|
| UAC-BarringPerPLMN ::= | SEQUENCE { |
| plmn-IdentityIndex | INTEGER (1..maxPLMN), |
| uac-ACBarringListType | CHOICE{ |

| | |
|---|---|
| uac-ImplicitACBarringList | SEQUENCE (SIZE(maxAccessCat-1)) OF UAC- |

BarringInfoSetIndex,

| | |
|---|---|
| uac-ExplicitACBarringList | UAC-BarringPerCatList |
| } | OPTIONAL -- Need S |

}
-- TAG-UAC-BARRINGPERPLMN-LIST-STOP
-- ASN1STOP

UAC-BarringPerPLMN-List field descriptions:

uac-ACBarringListType

Access control parameters for each access category valid only for a specific PLMN or SNPN.

plmn-IdentityIndex

Index of the PLMN or SNPN across the plmn-IdentityInfoList and npn-Identity InfoList fields included in SIB1.

Hereinafter, technical features related to Unified Access Control are described. Parts of section 6.22 of 3GPP TS 22.261 v18.6.0 may be referred.

Depending on operator's policies, deployment scenarios, subscriber profiles, and available services, different criterion will be used in determining which access attempt should be allowed or blocked when congestion occurs in the 5G System. These different criteria for access control are associated with Access Identities and Access Categories. The 5G system will provide a single unified access control where operators control accesses based on these two.

In unified access control, each access attempt is categorized into one or more of the Access Identities and one of the Access Categories. Based on the access control information applicable for the corresponding Access Identity and Access Category of the access attempt, the UE performs a test whether the actual access attempt can be made or not.

The unified access control supports extensibility to allow inclusion of additional standardized Access Identities and Access Categories and supports flexibility to allow operators to define operator-defined Access Categories using their own criterion (e.g. network slicing, application, and application server).

However, when a UE is configured for EAB, the UE is also configured for delay tolerant service for 5G system.

Based on operator policy, the 5G system shall be able to prevent UEs from accessing the network using relevant barring parameters that vary depending on Access Identity and Access Category. Access Identities are configured at the UE as listed in Table 9. Access Categories are defined by the combination of conditions related to UE and the type of access attempt as listed in Table 10. One or more Access Identities and only one Access Category are selected and tested for an access attempt.

The 5G network shall be able to broadcast barring control information (i.e. a list of barring parameters associated with an Access Identity and an Access Category) in one or more areas of the RAN.

The UE shall be able to determine whether or not a particular new access attempt is allowed based on barring parameters that the UE receives from the broadcast barring control information and the configuration in the UE.

In the case of multiple core networks sharing the same RAN, the RAN shall be able to apply access control for the different core networks individually.

The unified access control framework shall be applicable both to UEs accessing the 5G CN using E-UTRA and to UEs accessing the 5G CN using NR.

The unified access control framework shall be applicable to UEs in RRC Idle, RRC

Inactive, and RRC Connected at the time of initiating a new access attempt (e.g. new session request).
“new session request” in RRC Connected refers to events, e.g. new MMTEL voice or video session, sending of SMS (SMS over IP, or SMS over NAS), sending of IMS registration related signalling, new PDU session establishment, existing PDU session modification, and service request to re-establish the user plane for an existing PDU session.

The 5G system shall support means by which the operator can define operator-defined Access Categories to be mutually exclusive.
Examples of criterion of operator-defined Access Categories are network slicing, application, and application server.

The unified access control framework shall be applicable to inbound roamers to a PLMN.

The serving PLMN should be able to provide the definition of operator-defined Access Categories to the UE.

Table 9 shows an example of Access identities.

TABLE 9

| Access Identity | |
|---|---|
| number | UE configuration |
| 0 | UE is not configured with any parameters from this table |
| 1 (NOTE 1) | UE is configured for Multimedia Priority Service (MPS). |
| 2 (NOTE 2) | UE is configured for Mission Critical Service (MCS). |
| 3 | UE for which Disaster Condition applies (note 4) |
| 4-10 | Reserved for future use |
| 11 (NOTE 3) | Access Class 11 is configured in the UE. |
| 12 (NOTE 3) | Access Class 12 is configured in the UE. |
| 13 (NOTE 3) | Access Class 13 is configured in the UE. |
| 14 (NOTE 3) | Access Class 14 is configured in the UE. |
| 15 (NOTE 3) | Access Class 15 is configured in the UE. |

(NOTE 1):
Access Identity 1 is used by UEs configured for MPS, in the PLMNs where the configuration is valid. The PLMNs where the configuration is valid are HPLMN, PLMNs equivalent to HPLMN, and visited PLMNs of the home country. Access Identity 1 is also valid when the UE is explicitly authorized by the network based on specific configured PLMNs inside and outside the home country.
(NOTE 2):
Access Identity 2 is used by UEs configured for MCS, in the PLMNs where the configuration is valid. The PLMNs where the configuration is valid are HPLMN or PLMNs equivalent to HPLMN and visited PLMNs of the home country. Access Identity 2 is also valid when the UE is explicitly authorized by the network based on specific configured PLMNs inside and outside the home country.
(NOTE 3):
Access Identities 11 and 15 are valid in Home PLMN only if the EHPLMN list is not present or in any EHPLMN. Access Identities 12, 13 and 14 are valid in Home PLMN and visited PLMNs of home country only. For this purpose, the home country is defined as the country of the MCC part of the IMSI.
(NOTE 4):
The configuration is valid for PLMNs that indicate to potential Disaster Inbound Roamers that the UEs can access the PLMN.

Any number of these Access Identities may be barred at any one time.

Table 10 shows an example of Access categories.

TABLE 10

| Access Category | | |
|---|---|---|
| number | Conditions related to UE | Type of access attempt |
| 0 | All | MO signalling resulting from |
| | | paging |
| 1 (NOTE 1) | UE is configured for delay | All except for Emergency, or |
| | tolerant service and subject to | MO exception data |
| | access control for Access | |
| | Category 1, which is judged | |
| | based on relation of UE's | |
| | HPLMN and the selected | |
| | PLMN. | |
| 2 | All | Emergency |
| 3 | All except for the conditions in | MO signalling on NAS level |
| | Access Category 1. | resulting from other than paging |
| 4 | All except for the conditions in | MMTEL voice (NOTE 3) |
| | Access Category 1. | |
| 5 | All except for the conditions in | MMTEL video |
| | Access Category 1. | |
| 6 | All except for the conditions in | SMS |
| | Access Category 1. | |
| 7 | All except for the conditions in | MO data that do not belong to |
| | Access Category 1. | any other Access Categories |
| | | (NOTE 4) |
| 8 | All except for the conditions in | MO signalling on RRC level |
| | Access Category 1 | resulting from other than paging |
| 9 | All except for the conditions in | MO IMS registration related |
| | Access Category 1 | signalling (NOTE 5) |
| 10 (NOTE 6) | All | MO exception data |
| 11-31 | | Reserved standardized Access |
| | | Categories |
| 32-63 (NOTE 2) | All | Based on operator classification |

(NOTE 1):
The barring parameter for Access Category 1 is accompanied with information that define whether Access Category applies to UEs within one of the following categories:
a) UEs that are configured for delay tolerant service;
b) UEs that are configured for delay tolerant service and are neither in their HPLMN nor in a PLMN that is equivalent to it;
c) UEs that are configured for delay tolerant service and are neither in the PLMN listed as most preferred PLMN of the country where the UE is roaming in the operator-defined PLMN selector list on the SIM/USIM, nor in their HPLMN nor in a PLMN that is equivalent to their HPLMN. When a UE is configured for EAB, the UE is also configured for delay tolerant service. In case a UE is configured both for EAB and for EAB override, when upper layer indicates to override Access Category 1, then Access Category 1 is not applicable.
(NOTE 2):
When there are an Access Category based on operator classification and a standardized Access Category to both of which an access attempt can be categorized, and the standardized Access Category is neither 0 nor 2, the UE applies the Access Category based on operator classification. When there are an Access Category based on operator classification and a standardized Access Category to both of which an access attempt can be categorized, and the standardized Access Category is 0 or 2, the UE applies the standardized Access Category.
(NOTE 3):
Includes Real-Time Text (RTT).
(NOTE 4):
Includes IMS Messaging.
(NOTE 5):
Includes IMS registration related signalling, e.g. IMS initial registration, re-registration, and subscription refresh.
(NOTE 6):
Applies to access of a NB-IoT-capable UEto a NB-IOT cell connected to 5GC when the UE is authorized to send exception data.

Access Category 0 in Table 10 shall not be barred, irrespective of Access Identities.
The network can control the amount of access attempts relating to Access Category 0 by controlling whether to send paging or not.

Meanwhile, there is a mechanism known as Unified Access Control that restricts access in certain scenarios. It prevents selected access categories or access identities from sending initial access messages for load control purposes. The network configures barring control information associated with these access categories and access identities. The UE determines whether an access attempt is barred by checking the barring control information specific to the selected PLMN, access category, and access identities.

There are two reasons for restricting access attempts based on the UE mode, either aerial or terrestrial.

Firstly, the network may limit access attempts by UEs above a certain height for specific access categories or access identities in order to reduce uplink interference. Additionally, the network may be differentiating between aerial UEs specific to certain cells and terrestrial UEs specific to other cells. Consequently, the network's focus on connection may vary depending on the UE mode and the network type.

Secondly, in the case of aerial UEs, a swarm of these UEs can be utilized to enhance efficiency in tasks such as delivery, agriculture, and emergency rescue. Managing this swarm of aerial UEs falls on the network, which adds to its burden in addition to controlling terrestrial UEs. Therefore, the network may require access control for load balancing, taking into account the UE mode (aerial or terrestrial).

By implementing access control based on height conditions, in addition to selected PLMN, access category, and access identities, the network can efficiently perform load balancing while considering aerial UEs. This approach helps reduce the wastage of uplink resources for UEs operating at certain heights.

Therefore, studies for access barring check based on height in a wireless communication system are required.

Hereinafter, a method for access barring check based on height in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

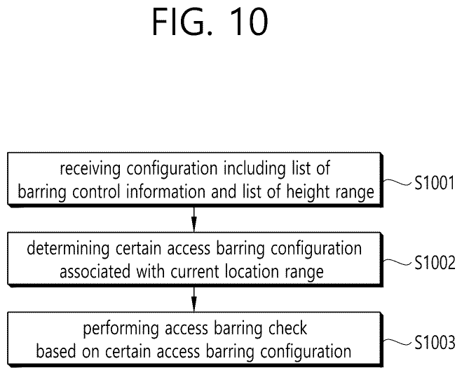

FIG. 10 shows an example of a method for access barring check based on height in a wireless communication system, according to some embodiments of the present disclosure.

In particular, FIG. 10 shows an example of a method performed by a wireless device in a wireless communication system.

In step S1001, a wireless device may receive, from a network, at least one access barring configuration. Each of the at least one access barring configuration may be associated with one or more location ranges.

For example, a wireless device may receive, from the network, (i) information on a list of the at least one access barring configuration, (ii) information on a list of the one or more location ranges, and (iii) mapping information between each of the at least one access barring configuration and the one or more location ranges.

For example, the at least one access barring configuration may include (i) information on a list of the at least one access barring configuration, (ii) information on a list of the one or more location ranges, and (iii) mapping information between each of the at least one access barring configuration and the one or more location ranges.

For example, each of the one or more location ranges may include (i) at least one height range and/or (ii) at least one zone. For example, the one or more location ranges may include a first location range consisting of a height range. For example, the one or more location ranges may include a second location range consisting of a zone. For example, the one or more location ranges may include a third location range consisting of both a height range and a zone.

In other words, the location of the wireless device may be represented by a height and a zone. That is, the location of the wireless device may be included in a height range and a zone range.

For example, the at least one access barring configuration may include one or more barring parameters associated with the one or more location ranges. For example, the one or more barring parameters may include a barring factor, a barring time, and/or one or more allowed access identities to access associated with an access category.

For example, the at least one access barring configuration may include information on one or more access categories associated with the one or more location ranges. For example, the information on one or more access categories may include information on a specific access category which is barred for a first location range and is not barred for a second location range. For example, the information on one or more access categories may include information on a specific access category which has a barring factor with higher probability of access attempt for a first location range and a barring factor with lower probability of access attempt for a second location range.

For example, the at least one access barring configuration may include information on one or more access identities associated with the one or more location ranges. For example, the information on one or more access identities may include information on a specific access identity which is allowed for a first location range and is barred for a second location range.

In step S1002, a wireless device may determine a certain access barring configuration associated with a certain location range to which a current location of the wireless device belongs.

For example, the wireless device may monitor the current location of the wireless device. The wireless device may determine the certain access barring configuration associated with the location range to which the current location of the wireless device belongs, whenever the location range to which the current location of the wireless device belongs is changed.

For example, the wireless device may monitor the height ranges and the zones where the wireless device belongs. The wireless device may determine the certain access barring configuration when the height ranges and the zones where the wireless device belongs is changed.

In step S1003, a wireless device may perform an access barring check based on the certain access barring configuration.

For example, the wireless device may perform the unified access control procedure using the selected Access Category and one or more Access Identities according to the determined access barring configuration, as in step S1002.

For example, when the wireless device may determine that an access attempt is barred, the wireless device may start a barring timer based on the barring time. For example, the barring timer may be determined based on the barring time and a random value between 0 to 1.

According to some embodiments of the present disclosure, the wireless device may be in communication with at least one of a user equipment, a network, or an autonomous vehicle other than the wireless device.

For example, the wireless device is a mobile device capable of vertical mobility.

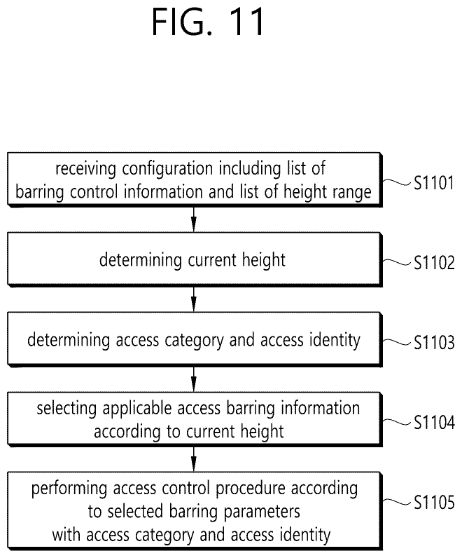

FIG. 11 shows some an example of a method for access barring check based on height in a wireless communication system, according to some embodiments of the present disclosure.

From network planning point of view, preferred barring control information may be different over different height of UE. Then, UE may select the barring control information based on height of UE. For instance, for a certain height, an aerial UE is restricted to access attempts according to the selected barring control information.

In step S1101, UE receives a configuration including list(s) of barring control information and a list of range(s) of heights from network.
A list of barring control information may be valid for all PLMNs/SNPNs, unless overwritten by the PLMN/SNPN specific configuration provided.
A list of barring control information may be valid only for a specific PLMN or SNPN.
Each barring control information may include barring parameters consisting of a barring factor, a barring time, and allowed access identities to access by access category.
Each height range may comprise a lowest height value and/or highest height value representing the target height range.
For the association between height ranges and list of barring control information, the following alternatives can be considered:
> Alt 1: Each height range may be associated with an explicit list of barring control information.
>> For each configured height range, an explicit list of barring control information can be configured.
>>Equivalently, for each configured list of barring control information, one or more applicable ranges can be configured.
>>Equivalently, for one or more applicable ranges, list of barring control information may not be configured.
> Alt 2: Each range may be associated with explicit access categories in the barring control information.
>>UE may be configured with a list of barring control information.
>> For each configured height range, an explicit access category can be configured.
> Alt 3: Each range may be associated with explicit access identities in the barring control information.
>>UE may be configured with a list of barring control information.
>> For each configured height range, an explicit access identity can be configured.

In step S1102, UE determines its current height.

In step S1103, UE determines the access category according to the type of access to network and determines the access identity.

In step S1104, UE selects applicable access barring information according to the determined height:

If the current height belongs to a certain height range, the UE selects applicable barring control information based on the association between the height range and barring control information.
> In Alt1 above is used, UE considers that the list of barring control information associated with the height range is only applicable. (Other barring control information not associated with the height range is considered non-applicable.)
> In Alt2 above is used, UE considers that one or more access categories associated with the height range in barring control information are available. That is, the UE considers that the barring control information related to the selected access categories according to the determined height are applicable. (Other barring control information not related to the selected access categories are considered non-applicable).
> In Alt3 above is used, UE considers that one or more access identities associated with the height range in barring control information are available. That is, the UE considers that the barring control information related to the selected access identities according to the determined height is applicable. (Other barring control information not related to the selected access identities is considered non-applicable).

In step S1105, UE performs the access control procedure according to the selected barring parameters with the determined access category and determined access identity.
UE performs access barring check for the determined access category and the determined access identity.
> UE draws a random number ‘rand’ distributed in the range: 0≤rand <1.
> UE considers the access attempt as allowed if ‘rand’ is lower than the barring factor. Otherwise, UE considers the access attempt as barred.
> If the access attempt is considered as barred, UE starts timer with the timer value calculated with the configured barring time.

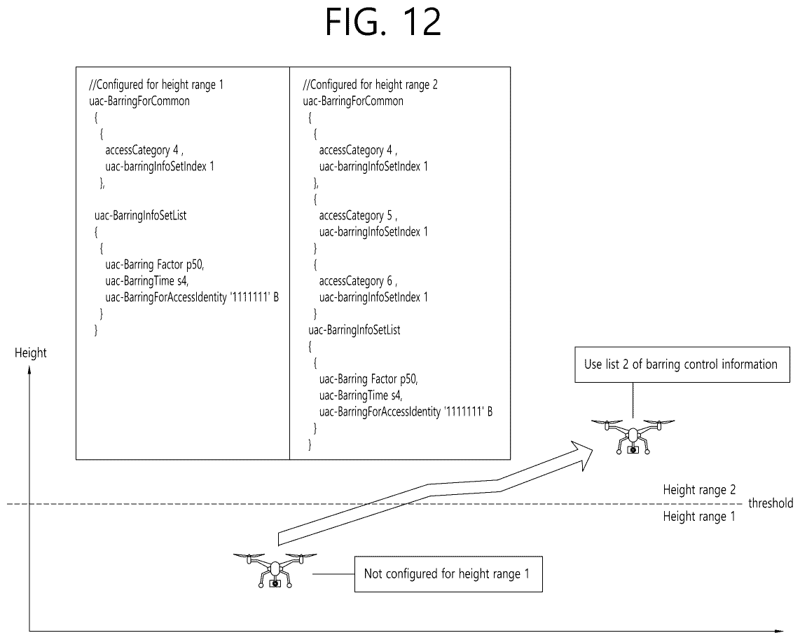

FIGS. 12, 13, 14, 15, and 16 show examples of barring control information over height configurations.

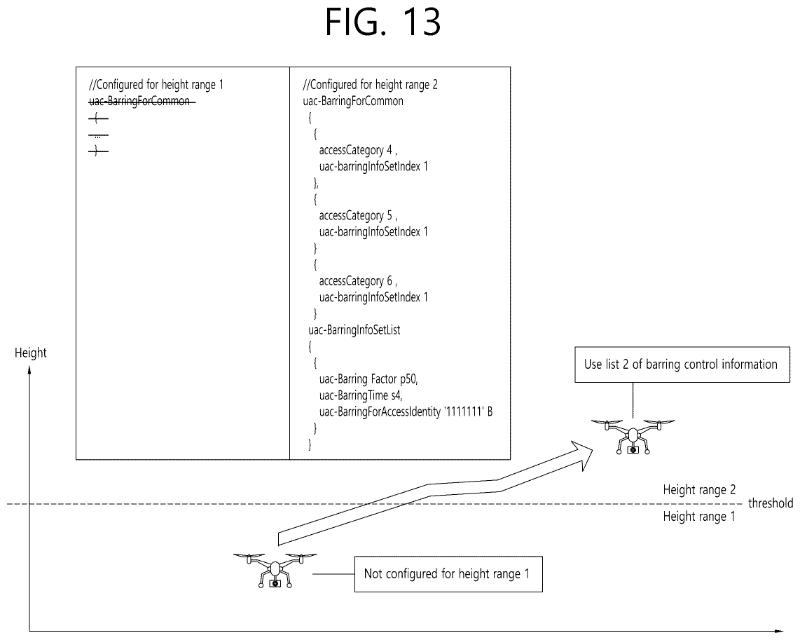

In particular, FIGS. 12 and 13 illustrate examples of a case of the Alt1 above in which each height range is associated with an explicit list of barring control information.

In FIGS. 12 and 13, a range of heights associated with a list of barring control information as following:
UE is configured a first and a second lists of barring control information.
Barring control information 1
> Barring control information 1 is applied for height range 1
Barring control information 2
> Barring control information 2 is applied for height range 2

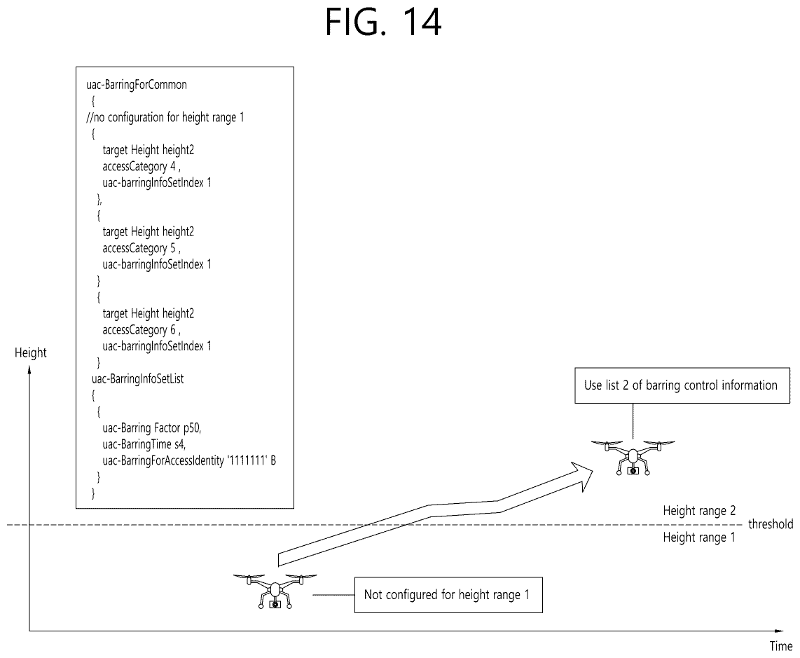

In particular, FIG. 14 illustrates examples of a first case of the Alt2 above (that is, Alt2_1) in which each range is associated with explicit access categories in the barring control information.

In FIG. 14, a range of heights associated with a certain access category as following:
Access Category 4
> Access Category 4 is allowed for access attempts for height range 1
> Access Category 4 is barred for access attempts according to the barring check for height range 2
Access Category 5
> Access Category 5 is allowed for access attempts for height range 1
> Access Category 5 is barred for access attempts according to the barring check for height range 2
Access Category 6
> Access Category 6 is allowed for access attempts for height range 1
> Access Category 6 is barred for access attempts according to the barring check for height range 2
Other Access Categories
> Considered as allowed for any height range.

Table 11 shows an example of the Access Categories for different height ranges.

TABLE 11

| | For Height range1, | For Height range2, |
|---|---|---|
| Access Category | Access parameters | Access parameters |
| Access Category 0 (MO signalling | Not configured | Not configured |
| resulting from paging) | | |
| Access Category 1 (All except for | Not configured | Not configured |
| Emergency, or MO exception data) | | |
| Access Category 2 (Emergency) | Not configured | Not configured |
| Access Category 3 (MO signalling on | Not configured | Not configured |
| NAS level resulting from other than | | |
| paging) | | |
| Access Category 4 (MMTEL voice) | Not configured | Configured |
| | (Allowed (not barred)) | (can be Barred) |
| Access Category 5 (MMTEL video) | Not configured | Configured |
| | (Allowed (not barred)) | (can be Barred) |
| Access Category 6 (SMS) | Not configured | Configured |
| | (Allowed (not barred)) | (can be Barred) |
| Access Category 7 (MO data that do | Not configured | Not configured |
| not belong to any other access | | |
| categories) | | |
| Access Category 8 (MO signalling on | Not configured | Not configured |
| RRC level resulting from other than | | |
| paging) | | |
| Access Category 9 (MO IMS | Not configured | Not configured |
| registration related signalling) | | |
| Access Category 10 (MO exception | Not configured | Not configured |
| data) | | |

If Alt2_1 above is used, UE is configured with different barring parameters by access category for different height range as following:
For Access Category 4 through Access Category 6, network may configure the barring parameters such as barring factor and the barring time for height range 2 only.
> For height range1, network may not configure barring parameters for all Access Categories.
> For height range2, network may configure barring parameters for Access Category 4 through Access Category 6. Network may not configure barring parameters for other Access Categories.

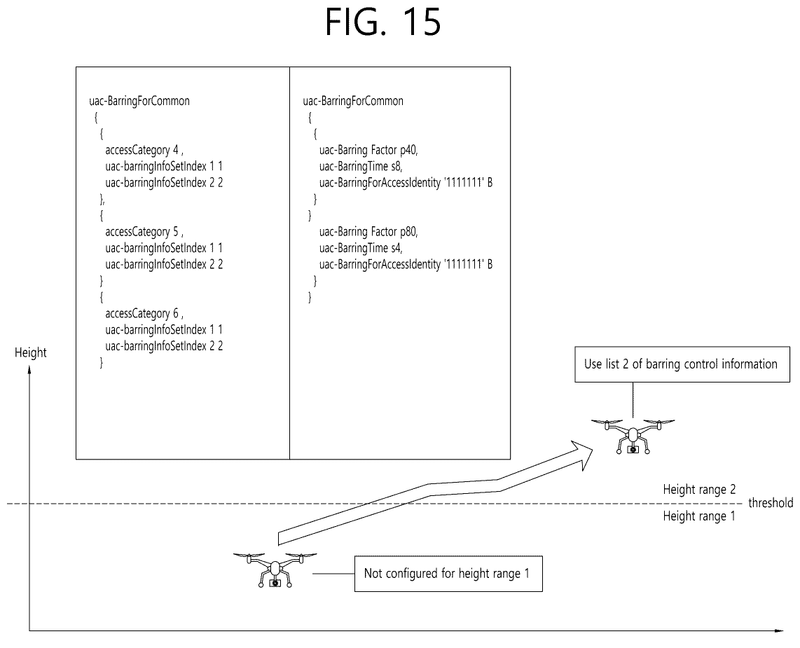

In particular, FIG. 15 illustrates examples of a second case of the Alt2 above (that is, Alt2_2) in which each range is associated with explicit access categories in the barring control information.

In FIG. 15, a range of heights associated with a certain access category as following:
Access Category 4
> Access Category 4 is barred for access attempts according to result of the barring check for height range 1. The probability of access attempt is high.
> Access Category 4 is barred for access attempts according to the result of the barring check for height range 2. The probability of access attempt is low.
Access Category 5
> Access Category 5 is barred for access attempts according to the result of the barring check for height range 1. The probability of access attempt is high.
> Access Category 5 is barred for access attempts according to the result of the barring check for height range 2. The probability of access attempt is low.
Access Category 6
> Access Category 6 is barred for access attempts according to the result of the barring check for height range 1. The probability of access attempt is high.
> Access Category 6 is barred for access attempts according to the result of the barring check for height range 2. The probability of access attempt is low.
Other Access Categories
> Considered as allowed for any height range.

Table 12 shows an example of the Access Categories for different height ranges.

TABLE 12

| | For Height range1, | For Height range2, |
|---|---|---|
| Access Category | Access parameters | Access parameters |
| Access Category 0 (MO signalling | Not configured | Not configured |
| resulting from paging) | | |
| Access Category 1 (All except for | Not configured | Not configured |
| Emergency, or MO exception data) | | |
| Access Category 2 (Emergency) | Not configured | Not configured |
| Access Category 3 (MO signalling on | Not configured | Not configured |
| NAS level resulting from other than | | |
| paging) | | |
| Access Category 4 (MMTEL voice) | Configured | Configured |
| | (including barring | (including barring |
| | factor with higher | factor with lower |
| | probability of access | probability of access |
| | attempt) | attempt) |
| Access Category 5 (MMTEL video) | Configured | Configured |
| | (including barring | (including barring |
| | factor with higher | factor with lower |
| | probability of access | probability of access |
| | attempt) | attempt) |
| Access Category 6 (SMS) | Configured | Configured |
| | (including barring | (including barring |
| | factor with higher | factor with lower |
| | probability of access | probability of access |
| | attempt) | attempt) |
| Access Category 7 (MO data that do not | Not configured | Not configured |
| belong to any other access categories) | | |
| Access Category 8 (MO signalling on | Not configured | Not configured |
| RRC level resulting from other than | | |
| paging) | | |
| Access Category 9 (MO IMS | Not configured | Not configured |
| registration related signalling) | | |
| Access Category 10 (MO exception | Not configured | Not configured |
| data) | | |

If Alt2_2 above is used, UE is configured with different barring parameters by access category for different height range as following:
For Access Category 4 through Access Category 6, network may configure different barring parameters such as the barring factor and the barring time for different heights range.
> For height range1, network may configure higher value of barring factor than for height range 2.
> For height range2, network may configure longer value of barring time than for height range 1.

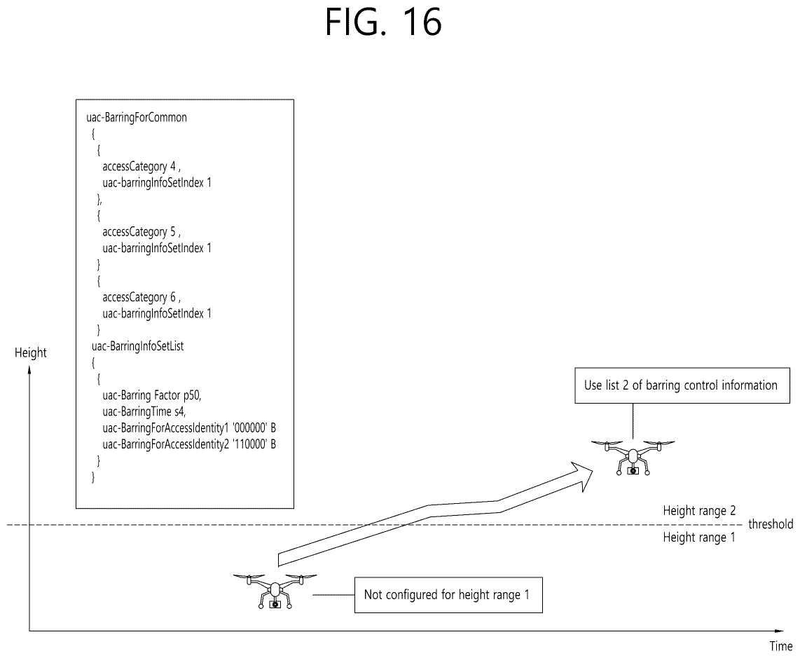

In particular, FIG. 16 illustrates examples of the Alt3 above in which each range may is associated with explicit access identities in the barring control information.

In FIG. 16, a range of heights associated with a certain access identity as following:
Access Identity 1
> UE associated with Access Identity 1 is allowed for access attempts for height range 1.
> UE associated with Access Identity 1 is barred for access attempts according to the result of the barring check for height range 2.
Access Identity 2
> UE associated with Access Identity 2 is allowed for access attempts for height range 1.
> UE associated with Access Identity 2 is barred for access attempts according to the result of the barring check for height range 2.
Access Identity 11 through Access Identity 15
> UE associated with Access Identity 11 through Access 15 is allowed for access attempts for height range 1.
> UE associated with Access Identity 11 through Access 15 is allowed for access attempts for height range 2.

### Other Access Identities

> Considered as allowed for any height range.

Table 13 shows an example of the Access Identities for different height ranges.

TABLE 13

| | For Height range1, | For Height range2, |
|---|---|---|
| Access Identity | Access parameters | Access parameters |
| Access Identity 0 (UE is not configured | Not configured | Not configured |
| with any parameter from this table) | | |
| Access Identity 1 (Configured for | Configured to Allow | Configured to |
| Multimedia Priority Service (MPS)) | | Disallow |
| | | (can be Barred) |
| Access Identity 2 (Configured for | Configured to Allow | Configured to |
| Mission Critical Service(MCS)) | | Disallow |
| | | (can be Barred) |
| Access Identity 3 (For which Disaster | Not configured | Not configured |
| Condition applies) | | |
| Access Identity 11 | Configured to Allow | Configured to Allow |
| Access Identity 12 | Configured to Allow | Configured to Allow |
| Access Identity 13 | Configured to Allow | Configured to Allow |
| Access Identity 14 | Configured to Allow | Configured to Allow |
| Access Identity 15 | Configured to Allow | Configured to Allow |

If Alt3 above is used, UE is configured with different access identities for different height range.
For Access Identity 1 and Access Identity 2, network may configure the barring parameters such as barring factor and the barring time for height range 2 only.
> For height range1, network may configure to allow for access attempts for all Access Categories.
> For height range2, network may configure to disallow for access attempts for Access Identity 1 and Access Identity 2. Network may configure to allow for access attempts for other Access Identities.

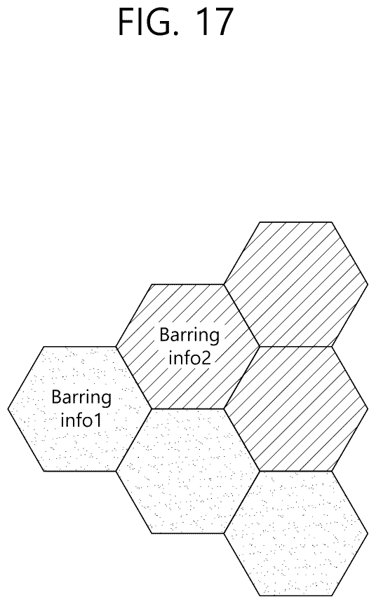

FIG. 17 shows an example of different barring information based on the location.

When coverage of a cell is very large, preferred barring control information may be different within the coverage. In such case, several sets of barring information may be configured for several areas within the cell. For instance, one set of barring information for a certain area may be configured and another set of barring information for another area may be configured. Then, based on the UE location, the UE selects the applicable barring information and applies the barring information for access control as specified above.

To associate barring information and applicable location, area information may be configured/specified for each set of barring information.
The area may be expressed by polygon to represent the closed area applicable for the associated barring information.
The area information may be expressed as one or more zones within regular structures.

For a certain UE location, if there is area specific barring information applicable for the UE location, the UE applies the barring information, and if not, the UE applies the default barring information.

For a certain UE location, if there is more than one area specific barring information applicable for the UE location, the UE selects a barring information covering smallest area among the applicable barring information sets.

It is also possible that applicable height and applicable area are jointly configured such that UE selects an applicable set of barring information based on its height and location jointly.

According to some embodiments of the present disclosure, a wireless device may receive access control configurations for a cell from a network.

The configuration may comprise a first access control configuration and a second access control configuration.

For example, each configuration may include one or more access parameters consisting of barring factor, barring time, and access identities by access category. For example, each configuration may be associated with a height threshold.

The wireless device may determine a current height.

The wireless device may determine an access category according to reason of access to network and access identity (ies).

The wireless device may apply an access control configuration based on the current height.

For example, the first access control configuration may be applied if the current height is larger than the height threshold,

For example, the second access control configuration may be applied if the current height is smaller than the height threshold,

The wireless device may perform barring check according to the determined access category and the determined access identity with applied access control configuration.

For example, the random value ‘rand’ distributed by UE is used to compare with the configured barring factor.

For example, the access attempt is considered as allowed if the ‘rand’ is lower than the configured barring factor.

For example, the access attempt is considered as barred if the ‘rand’ is higher than the configured barring factor.

For example, the wireless device may start barring time calculated with the configured barring time if access attempt is considered as barred.

For example, the wireless device may perform access attempts to network if access attempt is considered as allowed.

Some of the detailed steps shown in the examples of FIGS. 10−17 may not be essential steps and may be omitted. In addition to the steps shown in FIGS. 10−17, other steps may be added, and the order of the steps may vary. Some of the above steps may have their own technical meaning.

Hereinafter, an apparatus for access barring check based on height in a wireless communication system, according to some embodiments of the present disclosure, will be described. Herein, the apparatus may be a wireless device (100 or 200) in FIGS. 2, 3, and 5.

For example, a wireless device may perform the methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be adapted to be coupled operably with the memory 104 and the transceiver 106.

The processor 102 may be adapted to control the transceiver 106 to receive, from a network, at least one access barring configuration. Each of the at least one access barring configuration may be associated with one or more location ranges. The processor 102 may be adapted to determining a certain access barring configuration associated with a certain location range to which a current location of the wireless device belongs. The processor 102 may be adapted to perform an access barring check based on the certain access barring configuration.

For example, the processor 102 may be adapted to control the transceiver 106 to receive, from the network, (i) information on a list of the at least one access barring configuration, (ii) information on a list of the one or more location ranges, and (iii) mapping information between each of the at least one access barring configuration and the one or more location ranges.

For example, each of the one or more location ranges may include (i) at least one height range and/or (ii) at least one zone.

For example, the one or more location ranges may include a first location range consisting of a height range.

For example, the one or more location ranges may include a second location range consisting of a zone.

For example, the one or more location ranges may include a third location range consisting of both a height range and a zone.

For example, the at least one access barring configuration may include one or more barring parameters associated with the one or more location ranges.

For example, the one or more barring parameters may include a barring factor, a barring time, and/or one or more allowed access identities to access associated with an access category.

For example, the at least one access barring configuration may include information on one or more access categories associated with the one or more location ranges.

For example, the information on one or more access categories may include information on a specific access category which is barred for a first location range and is not barred for a second location range. For example, the information on one or more access categories may include information on a specific access category which has a barring factor with higher probability of access attempt for a first location range and a barring factor with lower probability of access attempt for a second location range.

For example, the at least one access barring configuration may include information on one or more access identities associated with the one or more location ranges.

For example, the information on one or more access identities may include information on a specific access identity which is allowed for a first location range and is barred for a second location range.

For example, the processor 102 may be adapted to control the transceiver 106 to be in communication with at least one of a user equipment, a network, or an autonomous vehicle other than the wireless device.

Hereinafter, a processor for a wireless device for access barring check based on height in a wireless communication system, according to some embodiments of the present disclosure, will be described.

The processor may be adapted to control the wireless device to receive, from a network, at least one access barring configuration. Each of the at least one access barring configuration may be associated with one or more location ranges. The processor may be adapted to control the wireless device to determining a certain access barring configuration associated with a certain location range to which a current location of the wireless device belongs. The processor may be adapted to control the wireless device to perform an access barring check based on the certain access barring configuration.

For example, the processor may be adapted to control the wireless device to receive, from the network, (i) information on a list of the at least one access barring configuration, (ii) information on a list of the one or more location ranges, and (iii) mapping information between each of the at least one access barring configuration and the one or more location ranges.

For example, each of the one or more location ranges may include (i) at least one height range and/or (ii) at least one zone.

For example, the one or more location ranges may include a first location range consisting of a height range.

For example, the one or more location ranges may include a second location range consisting of a zone.

For example, the one or more location ranges may include a third location range consisting of both a height range and a zone.

For example, the at least one access barring configuration may include one or more barring parameters associated with the one or more location ranges.

For example, the one or more barring parameters may include a barring factor, a barring time, and/or one or more allowed access identities to access associated with an access category.

For example, the at least one access barring configuration may include information on one or more access categories associated with the one or more location ranges.

For example, the information on one or more access categories may include information on a specific access category which is barred for a first location range and is not barred for a second location range. For example, the information on one or more access categories may include information on a specific access category which has a barring factor with higher probability of access attempt for a first location range and a barring factor with lower probability of access attempt for a second location range.

For example, the at least one access barring configuration may include information on one or more access identities associated with the one or more location ranges.

For example, the information on one or more access identities may include information on a specific access identity which is allowed for a first location range and is barred for a second location range.

For example, the processor may be adapted to control the wireless device to be in communication with at least one of a user equipment, a network, or an autonomous vehicle other than the wireless device.

Hereinafter, a non-transitory computer-readable medium has stored thereon a plurality of instructions for access barring check based on height in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive, from a network, at least one access barring configuration. Each of the at least one access barring configuration may be associated with one or more location ranges. The stored a plurality of instructions may cause the wireless device to determining a certain access barring configuration associated with a certain location range to which a current location of the wireless device belongs. The stored a plurality of instructions may cause the wireless device to perform an access barring check based on the certain access barring configuration.

For example, the stored a plurality of instructions may cause the wireless device to receive, from the network, (i) information on a list of the at least one access barring configuration, (ii) information on a list of the one or more location ranges, and (iii) mapping information between each of the at least one access barring configuration and the one or more location ranges.

For example, each of the one or more location ranges may include (i) at least one height range and/or (ii) at least one zone.

For example, the one or more location ranges may include a first location range consisting of a height range.

For example, the one or more location ranges may include a second location range consisting of a zone.

For example, the one or more location ranges may include a third location range consisting of both a height range and a zone.

For example, the at least one access barring configuration may include one or more barring parameters associated with the one or more location ranges.

For example, the one or more barring parameters may include a barring factor, a barring time, and/or one or more allowed access identities to access associated with an access category.

For example, the at least one access barring configuration may include information on one or more access categories associated with the one or more location ranges.

For example, the information on one or more access categories may include information on a specific access category which is barred for a first location range and is not barred for a second location range. For example, the information on one or more access categories may include information on a specific access category which has a barring factor with higher probability of access attempt for a first location range and a barring factor with lower probability of access attempt for a second location range.

For example, the at least one access barring configuration may include information on one or more access identities associated with the one or more location ranges.

For example, the information on one or more access identities may include information on a specific access identity which is allowed for a first location range and is barred for a second location range.

For example, the stored a plurality of instructions may cause the wireless device to be in communication with at least one of a user equipment, a network, or an autonomous vehicle other than the wireless device.

Hereinafter, a method performed by a base station (BS) for access barring check based on height in a wireless communication system, according to some embodiments of the present disclosure, will be described.

The BS may provide, to a wireless device, at least one access barring configuration. Each of the at least one access barring configuration is associated with one or more location ranges. The BS may receive, from the wireless device, an access attempt based on the access attempt being considered as allowed.

Hereinafter, a base station (BS) for access barring check based on height in a wireless communication system, according to some embodiments of the present disclosure, will be described.

The BS may include a transceiver, a memory, and a processor operatively coupled to the transceiver and the memory.

The processor may be adapted to control the transceiver to provide, to a wireless device, at least one access barring configuration. Each of the at least one access barring configuration is associated with one or more location ranges. The processor may be adapted to control the transceiver to receive, from the wireless device, an access attempt based on the access attempt being considered as allowed.

The present disclosure can have various advantageous effects.

According to some embodiments of the present disclosure, a wireless device could efficiently perform access barring check based on the current height.

For example, if the network performs access control with the height condition other than selected PLMN, access category and access identities, the network can efficiently perform load balancing in consideration of aerial UEs and reduce waste of UL resources for a certain height.

In other words, by implementing access control based on height conditions, in addition to selected PLMN, access categories, and access identities, the network can efficiently perform load balancing while taking into consideration aerial UEs, thereby reducing wastage of uplink (UL) resources for UEs operating at specific heights.

For example, by implementing location-based access control, it is possible to efficiently distribute the network load from aerial UEs.

For example, efficient utilization of resources is enabled for UEs located in specific locations.

For example, by applying access barring configuration based on location, UEs can connect to the network efficiently.

According to some embodiments of the present disclosure, a wireless network system could provide an efficient solution for access barring check considering the height of the wireless device.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method, comprising:
receiving, by a wireless device from a network, at least one access barring configuration, wherein each of the at least one access barring configuration is associated with one or more location ranges;
determining, by the wireless device, a certain access barring configuration associated with a certain location range to which a current location of the wireless device belongs; and
performing, by the wireless device, an access barring check based on the certain access barring configuration.

2. The method of claim 1, wherein the method further comprises,
receiving, by the wireless device from the network, (i) information on a list of the at least one access barring configuration, (ii) information on a list of the one or more location ranges, and (iii) mapping information between each of the at least one access barring configuration and the one or more location ranges.

3. The method of claim 1,
wherein each of the one or more location ranges includes (i) at least one height range and/or (ii) at least one zone.

4. The method of claim 3,
wherein the one or more location ranges includes a first location range consisting of a height range.

5. The method of claim 3,
wherein the one or more location ranges includes a second location range consisting of a zone.

6. The method of claim 3,
wherein the one or more location ranges includes a third location range consisting of both a height range and a zone.

7. The method of claim 1,
wherein the at least one access barring configuration includes one or more barring parameters associated with the one or more location ranges.

8. The method of claim 7,
wherein the one or more barring parameters include a barring factor, a barring time, and/or one or more allowed access identities to access associated with an access category.

9. The method of claim 1,
wherein the at least one access barring configuration includes information on one or more access categories associated with the one or more location ranges.

10. The method of claim 9,
wherein the information on one or more access categories includes information on a specific access category which is barred for a first location range and is not barred for a second location range.

11. The method of claim 9,
wherein the information on one or more access categories includes information on a specific access category which has a barring factor with higher probability of access attempt for a first location range and a barring factor with lower probability of access attempt for a second location range.

12. The method of claim 1,
wherein the at least one access barring configuration includes information on one or more access identities associated with the one or more location ranges.

13. The method of claim 12,
wherein the information on one or more access identities includes information on a specific access identity which is allowed for a first location range and is barred for a second location range.

14. The method of claim 1,
wherein the wireless device is in communication with at least one of a user equipment, a network, or an autonomous vehicle other than the wireless device.

15. A wireless device, comprising:
a transceiver;
a memory; and
at least one processor operatively coupled to the transceiver and the memory, and adapted to:
control the transceiver to receive, from a network, at least one access barring configuration, wherein each of the at least one access barring configuration is associated with one or more location ranges;
determine a certain access barring configuration associated with a certain location range to which a current location of the wireless device belongs; and
perform an access barring check based on the certain access barring configuration.

16. The wireless device of claim 15, wherein the at least one processor is further adapted to,
control the transceiver to receive, from the network, (i) information on a list of the at least one access barring configuration, (ii) information on a list of the one or more location ranges, and (iii) mapping information between each of the at least one access barring configuration and the one or more location ranges.

17. The wireless device of claim 15,
wherein each of the one or more location ranges includes (i) at least one height range and/or (ii) at least one zone.

18. The wireless device of claim 17,
wherein the one or more location ranges includes a first location range consisting of a height range.

19. The wireless device of claim 17,
wherein the one or more location ranges includes a second location range consisting of a zone.

20-31. (canceled)

32. A base station in a wireless communication system comprising:
a transceiver;
a memory; and
a processor operatively coupled to the transceiver and the memory, and adapted to:
provide, to a wireless device, at least one access barring configuration,
wherein each of the at least one access barring configuration is associated with one or more location ranges; and
receive, from the wireless device, an access attempt based on the access attempt being considered as allowed.
